(19) United States
(12) Patent Application Publication
(10) Pub. No.: US 2007/0223768 A1
(43) Pub. Date: Sep. 27, 2007

(54) Spring tension mounting mechanism for speakers and electronic modules

(76) Inventors: Carla Nadine Johnson, Lawrenceville, NJ (US); Jeremy M. Martin, West Palm, FL (US)

Correspondence Address: Carla N. Johnson, 71 Greenfield Ave, Lawrenceville, NJ, 08648, US

(21) Appl. No.: 11/369,149

(22) Filed: Mar. 6, 2006

(51) Int. Cl. H04R 1/02

(52) U.S. Cl. 381/386; 381/87

(57) ABSTRACT

A pair of portable speaker enclosures; or, an enclosure connecting together two opposing sides by interlocking slider structures. A spring-loaded tension mechanism permits the sliding of said connector slider structures with respect to one another, for the extension thereof and the shortening thereof. The tension mechanism exerts a friction between the slider structures to hold the slider structures at a desired overlapping position to one another. One or more spring U-like clamps sized may be used to grip about the edge of a panel display to which the enclosures may be mounted are connected to each enclosure. The U-like clamps are mounted to the enclosures by various methods, whereby one of the methods utilizes a rubber-like non-slip sheet over the base web of each U-like clamp. When plural opposing enclosures are present, cable take-up reels may be employed between enclosures.

### BACKGROUND OF THE INVENTION

The present invention is directed to a device to be used for mounting various devices and/or signage to thin structures with defined opposing edges, such as LCD flat panel displays, Laptop computers, PDAs, three-dimensional signage, tray-like structures, or similar structures allowing an extensible device to utilize tension on opposing sides to hold itself in place on multiple sized objects.

Other structures in the past have used suction cups, spring based clips and more permanent measures, such as screws, nails, and adhesive to achieve similar mounting capabilities.

What is desired is a mechanism, which can be spring mounted to a suitable panel and held in position by spring tension. On this device any multitude of devices could be attached to the mechanism for use or display with the object it is being mounted on such as speakers, signage, fans, displays, electronic buttons, removable/detachable devices, canisters, or anything else suitable for the designated use.

What is also desired is a spring or friction holding scheme for an extensible clamping mechanism. This mechanism would enable expansion and contraction of the sides of the mechanism allowing it to be attached to more narrow objects or wider objects. The inner sides of this mechanism cold employ traction-oriented material, such as rubber or foam, to maintain secured friction.

What is further desired is a cable length take-up mechanism for permitting cable length adjustment between opposing sides when mounted to various sized panels. This cable would enable devices attached to both receive power from a power supply, as well as provide electronic communication between devices attached to the mechanism and the object being attached thereon, if necessary.

### SUMMARY OF THE INVENTION

The objectives for the present invention are realized in such a device as a pair of portable speakers enclosures which are connected together by an extensible slider bar or tube. This slider has two members, one of which is connected to each enclosure. The slider members are interlocked with one inside the other. A friction spring connected to the inner slider exerts a force on the interior of the outer slider. This force is sufficient to hold the slider bar to a desired length, but is overcome by the manually exerted force of an operator. Once the operator again set the length of the slider bar, the friction spring holds that position.

As an alternative, a wind-up circular spring and tensioning reel could be used as a tensioning device between the two slider members. In this embodiment, a fine cable would be connected to one of the slider members while the circular spring and tensioning reel would be connected to the other slider member. An adjustment screw would set the tensioning force.

This tensioning structure could be mounted within the slider members or external thereto. An external mounting would normally include a cover to finish the structure.

One or more spring U-Like clamps, sized to grip about the edge of a panel display to which the enclosures may be mounted, may be mounted onto each enclosure and are to be used to position each enclosure on to a panel display. The U-type clamps are passive structures made preferably of spring metal. These U-Like clamps may or may not be rubber coated. Such rubber coating would act as a gripping surface to keep the enclosures from sliding downward when vertically mounted, or to assist in holding a device inverted if mounting on the bottom of a panel laying horizontally. The U-Like clamps are mounted to the enclosures by any of a number of various methods. One of the methods utilizes a rubber-like non-slip sheet which may be attached by glue, tacks, rivets, screws, snaps or pins, to the enclosure when extending over the base web of each U-like clamp.

When plural opposing enclosures are present, cable take-up reels may be employed between closures. These reels are placed in the speaker enclosure, which has the cable connections. However, they can be positioned in the other or far enclosure or within one of the slider bars. In the alternative, a pair of take-up reels may be employed in each slider bar, thereby reducing the size requirements for a single reel and providing a certain amount of redundancy, should one reel become jammed or have its spring weaken.

In this speaker enclosure example, speakers would utilize the electronic cabling within the tension mechanism to send audio signals to either side's speakers. Each speaker enclosure could be built on to the tension mechanism. The modularity would be achieved by providing hook-like structures, capable of conducting audio signals and/or electricity to each side providing them with the necessary signals to make them functional. This modularity would enable the disassembly of the device for storing, as well as for easy replacement of parts or for enabling other devices to utilize the current for add-on capabilities, such as lighting, fans, displays or other suitable use.

The portable speaker enclosures of the present invention can also be mounted onto other electronic devices, such as boom boxes and DVD players. A spring-loaded cord or fine plastic cable could provide the tension function on the slider members. Rubber-like traction grips, sized for the electronic device and mounted to the speaker enclosure, would be used to attach each speaker enclosure of the electronic devices.

In a further alternative, the slider members could be replaced with one or a pair of tensioned ribbon-type straps which pass between each speaker enclosures, with a tensioning device located within one or both enclosures. U-type clamps or rubber grips would be sized for the electronic device. The tensioned ribbon{s} would be positioned on the rear of the electronic device.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is a front view of the speaker enclosures of the present invention mounted onto the display panel of a laptop computer;

FIG. 2 is a front view of the speaker enclosures of FIG. 1. With the slider in and extended position;

FIG. 3. Is perspective view of a second {shaped} pair of enclosures mounted to the display of a laptop computer;

FIG. 4. Is a front view of the pair of enclosures of FIG. 3. Mounted to a flat panel television set;

FIG. 5 is a partial cross-sectional, plan view of the television set of FIG. 4 taken as shown in that figure;

FIG. 6 is plan view of the speaker enclosures of FIG. 2;

FIG. 7 is a partial cut-away view of speaker enclosures with a first cable take-up reel arrangement;

FIG. 8 is a partial cut-away front view of a speaker enclosure and slider member with a second take-up reel arrangement.

FIG. 9 is an exploded assembly view of a speaker enclosure, pair or U-Type clamps and gripping, hold-down, attachment matt;

FIG. 10 is a top view of the assembly of FIG. 9.

FIG. 11 is a top view of an alternate assembly for the enclosure clamps;

FIG. 12 is a partial cut-away plan view taken as shown in FIG. 7.

FIG. 13 is a front view of the two members of a rectangular tube slider about to be joined;

FIG. 14 is a front view of the two members of the slider of FIG. 13 joined.

FIG. 15a is a top, plan view of the two members of the slider of FIG. 13 with friction device; Device shown therein;

FIG. 15b is a top, plan view of FIG. 13 with a first alternate friction device;

FIG. 15c is a top, plan view of FIG. 13 with a second alternate friction device;

FIG. 16 is a plan view of a single enclosure mounted to a flat panel with a gripper on the opposite side from the speaker enclosure; and

FIG. 17 is a plan view of a pair of enclosures with large sized gripper clamps and a tensioned ribbon cable substituted for the sliders.

### DETAILED DESCRIPTION OF THE INVENTION

The present invention is a spring mounting structure and a portable auxiliary speaker system for electronic devices, for removably mounting enclosures to thin structures with defined opposing edges, such as a flat panel monitor or television set. The primary example used is a pair of speakers mounted to the spring mounting structure to create a portable speaker set or similar.

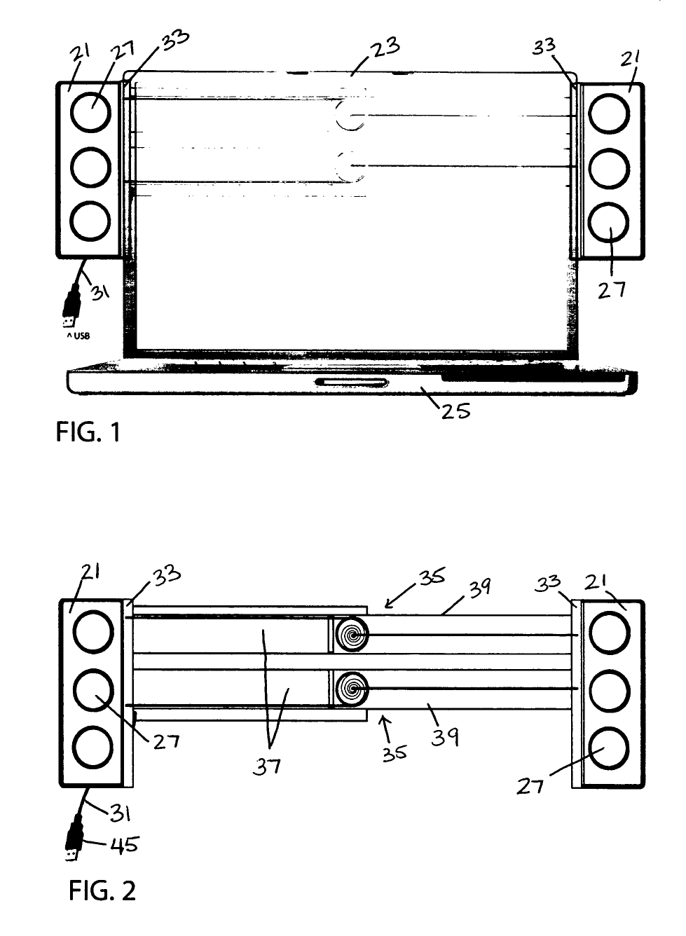

A pair of speaker enclosures 21, FIG. 1, is mounted, one each to opposites sides of an LCD display panel 23 of a laptop computer 25. The speakers 27 within the enclosures 21 can be either passive or actively powered. A pair of speaker cables connects one of the speaker enclosures to the laptop computer. These cables include a standard speaker cable 29 with an RCA-type jack and a USB cable 1, with a USB connector. Clips/clamps of spring material 33 are mounted to each speaker enclosure 21 and slip over the edge of the display panel 23 on both sides of the panel 23.

The speaker enclosures 21 are connected together by an expansible slider bar structure 35, FIG. 2, having a first large rectangular cross-section tube 37 and a slightly smaller rectangular cross-section tube 39, which smaller tube sized to slide inside of the larger tube 37. For greater stability, two pairs of spring clips/clamps 33, one on each enclosure 21, and a pair of expansible slider bars 35 are used.

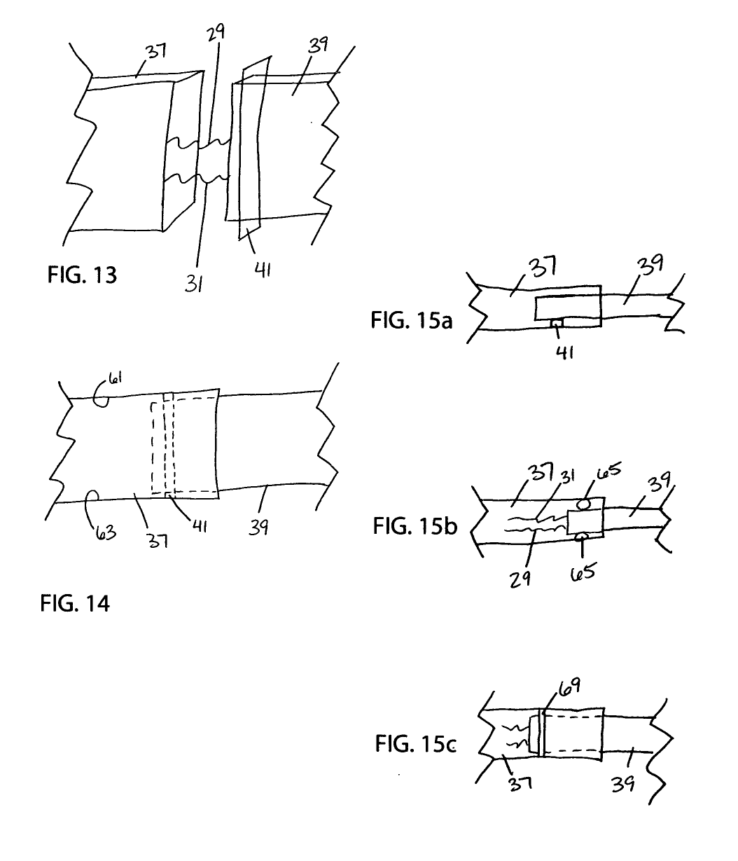

The slider bars 37, 39 make a longer or shorter extension structure, depending upon the position achieved by their movement by an operator. A spring-type friction member 41 {Friction spring} is attached near the free end of the smaller tube 39 {show in FIG. 13 not FIG. 2} creates a friction hold to the inside of the larger extension tube 37.

The speaker cables 29, 31 extend from one of {Left} the enclosures and terminate in a co-axial or tri-axial jack 43, and a USB plug 45, respectively. These cables are routed to the other {right} enclosure 21 through the slider bar structure 35, as shown on other views.

The enclosures 21 can be made of other shapes, such as the curved shape 45 shown in FIG. 3. Here, instead of the pair of smaller tab spring clamps 33, and may have a friction surface greater than the paired clamps 33.

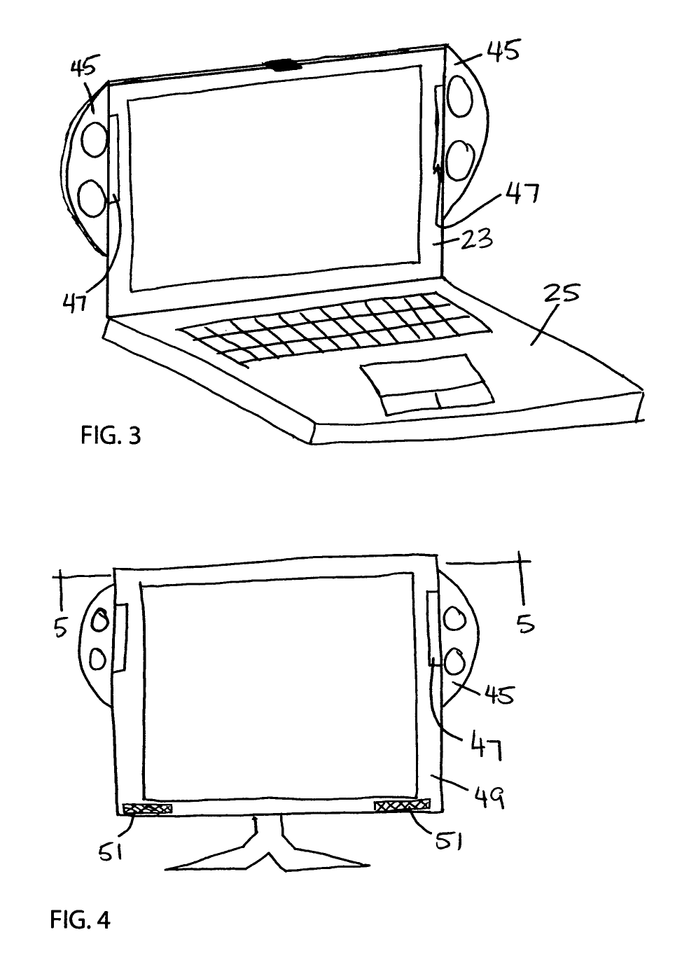

The enclosures 45 are shown mounted to the monitor/display panel 23 of a laptop computer 25 in FIG. 3. These same enclosures 45 could also be mounted to a flat panel television sown in FIG. 4. The auxiliary speakers in the enclosures 45 can be used to replace or to supplement the speakers 51. Which normally are provided with the television 49.

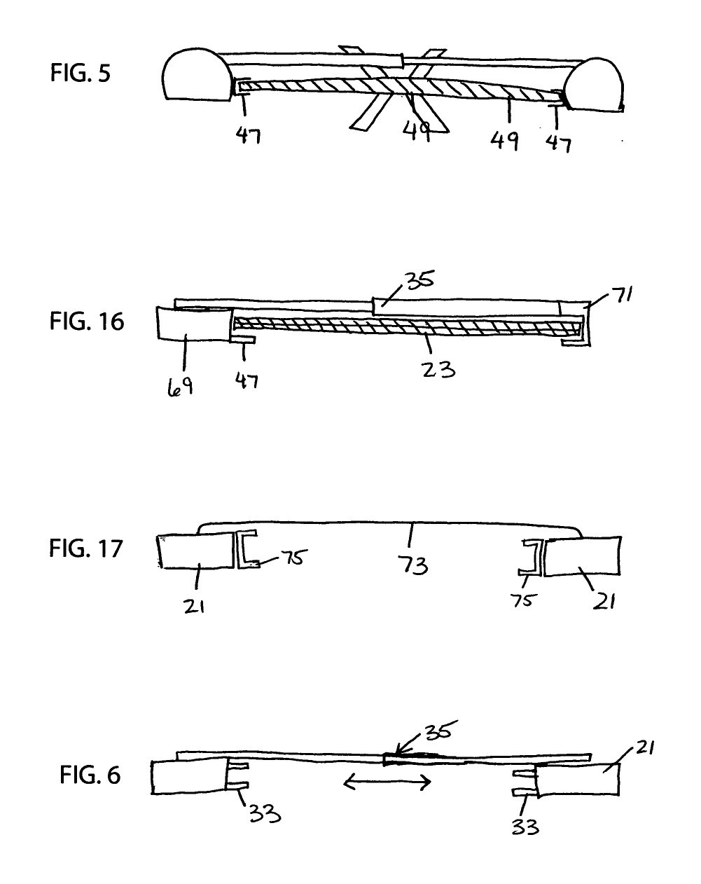

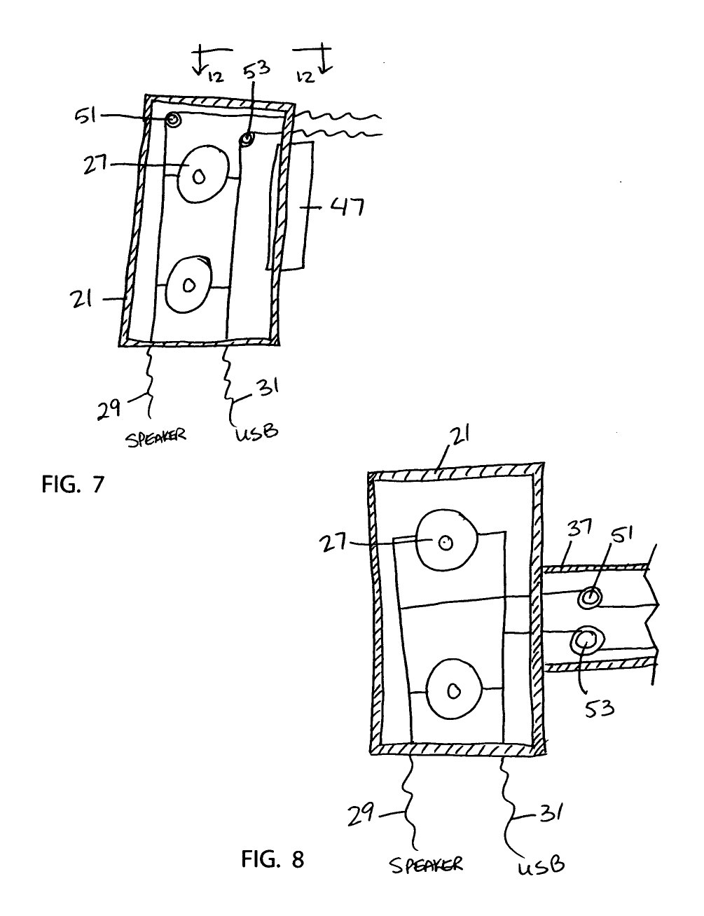

FIG. 5. Shows a representative mounting arrangement for a pair of enclosures 45 regardless of size or shape {such as the rectangular enclosures 25}. The clamp 47 or clamps 33 are generally U-Shape and slightly undersized to the depth of the panel 49, 23 respectively. This sizing will permit the clips/clamps to slip onto the panel with a slight spring distortion providing a slight clamping functioning. Thereby a friction fit is achieved. This friction fit is enhanced when the inside walls of the clamps 33, 45 are covered with a rubber-like or other slide resistant material.

The enclosure assembly can be extended so that the speaker enclosures are drawn apart, as shown in FIG. 6. This permits the assembly to be positioned about the panel to which it is to be mounted, and then closed upon itself to close the slider bar structure. This brings the speaker enclosures themselves into contact with the side edges of a panel. The friction spring 41 holds the collapsed length of the slider bar structure which has been mechanically positioned by an operator.

It is desirable to keep the cables 29, 31 which run the length of the slider bar structure 35 from kinking or being caught or cut by an edge of a stub, as the slider bars are slid in and out of one another. To this end, a pair of spring-loaded pay-out and reel-in the cables 29, 31, respectively, as the slider bar structure 35 extends and compresses. As an alternative, the reels 51, 53, can be mounted inside of the larger rectangular tube 37.

Further, they can also be, alternatively mounted in the other {right} enclosure 21. Further alternatively, pairs of pay-out/take-up reels can be used. In this instance, there would be one pay-out/take-up reel in each cable in each enclosure 21 for each able 29. 31, or tow reels in the slider bar structure 35, one in each slider bar tube 37, 39.

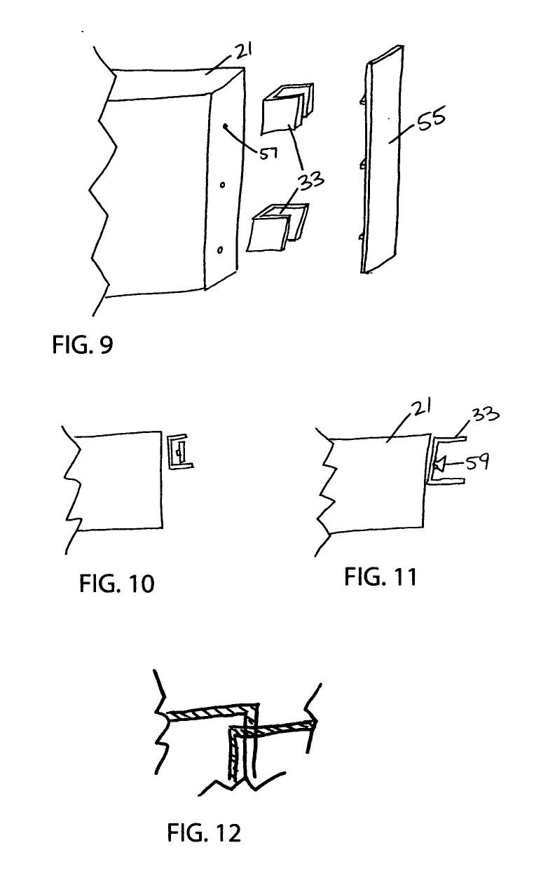

FIG. 9 illustrates the mounting of a pair of spring clips/clamps 33 to the enclosure 21 with an adhesively coated rubber-like sheet 55. When rubber-like is discussed herein, it is with an adhesively coated rubber-like sheet 55. When the rubber-like is discussed herein, it is understood that other soft and grip-type materials, such as soft vinyl, foam, polypropylene, and other soft thermoplastic materials, which exhibit a tacky surface may be substituted.

The sheet 55 extends the entire length of the enclosure 21 and is used to secure each clip/clamp 33 to the enclosures as well as provide a sticky or friction face for the enclosure against the display panel 23. Various methods can be used to secure the sheet 55 and the clamps 33 to the enclosure. These included glue, tacks staples, rivet, and snaps as shown in FIG. 9, The snap will pass through the clamp 33 and into a receiving hole 57 in the enclosure wall. This is illustrated in FIG. 10.

Flat-head, counter-sunk fasteners, such as a screw 59, FIG. 11, or a rivet {not shown} can also be satisfactorily used to secure a clamp 33, 47 to an enclosure 21, 45. Where the surface area of the clamp 47 is sufficiently large, the sheet 55 can be eliminated.

A clamp 33, 47 can also be mounted to the inside of an enclosure 21, 45 wall and pass out through the wall, FIG. 12.

The friction spring 41 that maintains an established slider bar position, is a ribbon-like spring steel member 41, FIG. 13, which is mounted near the free end of the smaller cross section rectangular slider tube 39 and extends above and below the top and bottom edges. When the smaller tube 39 is inserted into the larger cross-section tube 37, the friction spring 41 is forced against the inside top and bottom surfaces 61, 63, of the larger tube 37 to exert a force thereto, FIG. 14. In this manner, a friction force holds the position of the tubes 37, 39 with respect to one another. The friction positioning force is overcome by the strength of an operator opening {lengthening} or closing {shortening} the slider bar structure 35.

The friction spring 41, FIG. 15a, can substituted for with other structures, such as the dual springs 65 shown in FIG. 15b. and the O-ring 67 shown in FIG. 15c. In the instance of the O-ring 67, that ring can be of rubber, polypropylene, another compressible thermoplastic, or a coil spring wound as a toroid.

When single enclosure 69 is to be mounted on a display panel 23, the slider bar structure 35 is connected merely to an elongate clamp 71 which mounts to and about the opposite side of the panel 23, FIG. 16.

The slider bar structure 35 can be replaced by a ribbon band 73 which extends between the enclosures 21, FIG. 17. In this embodiment, the {left and right} enclosures 21 are attached to extra large spring clamps 75 which are capable of being mounted to a device with a greater depth size, such as a DVD player, radio, or boom box.

The ribbon band 73, FIG. 17. Can be reeled in or reeled out to set the distance between the enclosures 21 to the size of the device. A tensioning and fixing device provides a slight tensioning force to hold that distance between the enclosures 21.

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

1. A slider structure connecting said two brackets; and a tension mechanism within said slider structure capable of exerting a friction pressure to hold said slider at a desired position.

2. A set of cables within said sliding structure to provide tension and electricity or electronic communication between bracketed devices and/or the host device.

3. A bracket, which may feature a hook-like connector to facilitate communication between host and mounted devices.

4. A speaker system, comprising;
a. A pair of portable speaker enclosures:
b. A bracket on each speaker enclosure for engaging a relatively flat panel;
c. A slider structure connecting said two speaker enclosures; and a tension mechanism within said slider structure capable of exerting a friction pressure to hold said slider structure at a desired position.
